(19) United States
(12) Patent Application Publication
(10) Pub. No.: US 2007/0266590 A1
(43) Pub. Date: Nov. 22, 2007

(54) Drying device and method

(75) Inventors: Gerhard Hehenberger, Eggenberg (AT); Johannes Remili, Wilhering (AT)

Correspondence Address: TIAJOLOFF & KELLY, CHRYSLER BUILDING, 37TH FLOOR, 405 LEXINGTON AVENUE, NEW YORK, NY, 10174, US

(73) Assignee: ECON Maschinenbau und Steuerungstechnik GmbH, Pasching (AT)

(21) Appl. No.: 11/732,111

(22) Filed: Apr. 2, 2007

(30) Foreign Application Priority Data
Apr. 6, 2006 (AT) GM 273/2006

(51) Int. Cl. F26B 3/06

(52) U.S. Cl. 34/498

(57) ABSTRACT

Process for the drying of plastic granulates composed of any base materials, especially of composite materials, the granulates being produced using the under-water or water-ring granulation principle or a similar technology where the granulate is fed from the granulating device to a gravity water separator (1) by means of a processing water stream and thereafter to a drying device (2), whereby inside the drying device (2), heated ambient air is aspirated through the granulate, the supplied heat content of the heated ambient air being extracted from the processing water by means of heat exchanger (12). The drying device (2) comprises a housing (8) with a superimposed exhaust hood (9), a fan (10) disposed inside the exhaust hood (9) for the removal of the moist drying air, an air inlet embodied as an air filter (11), an air-permeable conveyor device (6) for the transport of the granulate through the drying device (2) and an air heating device (12) disposed between the air filter (11) and the conveyor device (6).

### FIELD OF THE INVENTION

The present invention concerns a drying device for plastic granulates produced by means of under-water or water-ring granulation from all types of plastics known to be suitable for this purpose, but in particular including composite materials. Composite granulates in accordance with the present invention are all conventional plastics present in a mixture with other organic or inorganic substances, e.g., wood fiber, glass fiber or other additives, or mixtures of additives as well.

### BACKGROUND OF THE INVENTION

In under-water or water-ring granulation, molten plastic is forced through the nozzles of an orifice plate and cut off at the nozzle outlet by a rotating blade. Due to the effect of the water, the cut granules automatically assume an approximately spherical shape. The plastic granulate is transported to a water separation and drying device by means of processing water.

Conventional drying devices may feature as their main component a centrifuge dryer wherein the plastic granulate is separated from the processing water by centrifugal forces. The centrifugal effects can be adjusted such that the granulate exiting the centrifugal dryer exhibits residual surface moisture of up to 0.1%.

However, the plastic granulate is exposed to high mechanical loads due to the centrifugal forces in a centrifugal dryer, resulting in surface roughness of the plastic pellets. Especially in composite granulates these mechanical loads can also result in damage of the plastic granulates since they are generally more brittle, which results in higher dust content.

Another problem is the abrasive effect on the centrifuge dryer baffles which must be therefore repaired or replaced regularly. This abrasive wear is particularly great with composite granulates, and among them, especially those containing glass fiber.

Another disadvantage is the great cleaning expense when the granulate load is changed, for example when the color is altered. Then the centrifugal dryer has to be completely cleaned of all adhering granulate remnants before a load can be processed.

It is known from DE 103 49 016, which describes a process for producing PET granulate, to subject the granulate, after under-water granulation and after water separation, to shaking or vibration during a subsequent heat treatment. During this phase a fluid stream can pass through the pellets and it is imaginable that the pellets are swirled about by the fluid. In another further development of this idea, DE 10 2004 021 595 describes that the fluid is warmer than the ambient room temperature. This document also mentions that the granulation and drying device is followed by a transport device in form of an oscillating conveyor or a conveyor trough.

Other known drying methods utilize a swirl or flow bed where the plastic granulate is separated from adhering processing water by a fluid such as for example an inert gas or air.

### SUMMARY OF THE INVENTION

The subject of the present invention is to create a process and a device which in particular serves to implement this process making it possible to dry plastic granulates made of any material, especially composite material, such that a drying completely free of wear is achieved. Another object is optimization of the energy requirements for the drying. A third object is to further reduce the adhering residual moisture to prevent problems during long-term storage and further processing, especially where composite granulates are concerned.

The object is achieved by a process having the technical features of Claim 1, as well as by a device with the technical features of Claim 7. Advantageous further developments are subjects of the dependent claims.

### BRIEF DESCRIPTION OF THE DRAWINGS

FIG. 1 is an elevational view of a device for the implementation of the process according to the invention.

FIG. 2 is an elevational view of an alternate embodiment of a device for the implementation of the process according to the invention.

### DETAILED DESCRIPTION

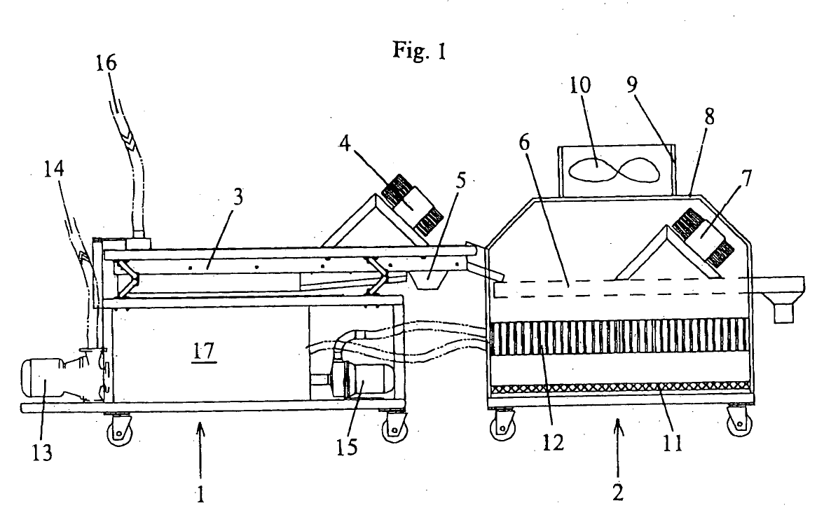

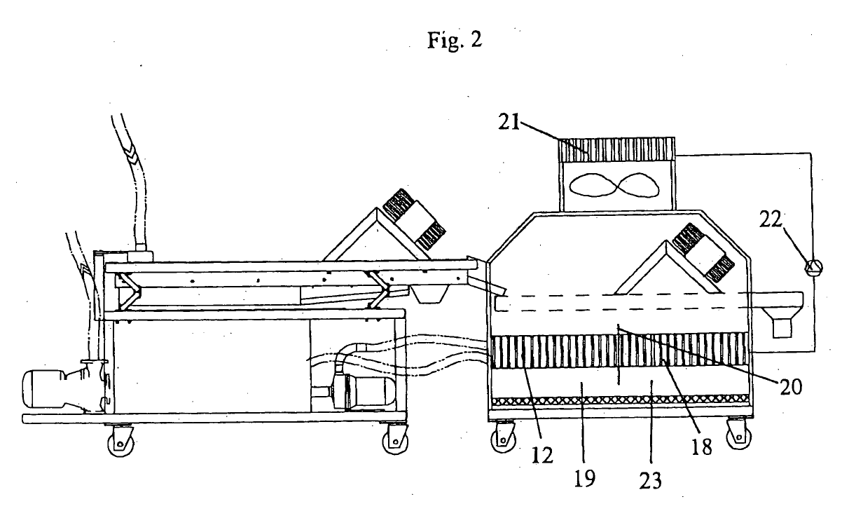

One possible embodiment of the invention is explained by way of drawings, where FIG. 1 shows a device for the implementation of the process according to the invention. An advantageous further development of the device in FIG. 1 is shown in FIG. 2.

The granulate exits the granulation apparatus (not shown) and is transported by a process water supply 16 to a perforated vibrating chute 3. The drained process water is collected in the water tank 17 located below. The vibrating chute 3 is functionally connected to at least one conventional vibrator 4. After passing through an oversize grain separator 5, the granulate with adhering residual moisture is transferred to a second vibrating chute 6 which in turn is also functionally linked with at least one vibrator 7. The vibrating chute 6 is disposed in a housing 8 which is provided with an exhaust hood 9 comprising a fan 10. An air inlet with an air filter 11 is disposed in the floor area of the housing 8. At least one heat exchanger 12 is arranged between the air filter 11 and the vibrating chute 6. The processing water 1 collected in the water tank 3 is returned by a pump 13 to the granulating unit by way of a drain line 14.

The processing water is heated by the introduction of the granulate. The amount of the added heat primarily depends on the composition of the granulate. However, the temperature of the processing water may not exceed a predetermined value. In conventional granulating units, processing water temperature is kept below said value by means of a water-to-water heat exchanger. The heat content of the discharged processing water is lost.

In the process according to the invention however, the heat content of the processing water is used to heat the drying air in the heat exchanger 12. The colder water regained from the heat exchanger 12 via the cooling water pump 15 is either returned to the water tank 17, and from there via pump 13 to the granulating unit or it is fed directly back to the granulating unit.

By this heating of the drying air which is aspirated by the fan 10 through the granulate disposed on the vibrating chute 6, the residual surface moisture adhering to the granulate product can be reduced to 0.01% or even further, resulting in a substantial increase of long-term storage stability of the granulate, and especially of its properties related to further processing.

In FIG. 2, the space underneath the vibrating chute 6 is completely or partially divided into smaller spaces that are separated from one another by a is sheet metal divider 20. Two heat exchangers 12 and 18 are arranged between the vibrating chute 6 and the air filter 11. The drying air aspirated by the fan 10 is partially heated by the first heat exchanger 12 in the manner described above and is passed through the granulate disposed on the perforated vibrating sheet 6. The heat content of this first heat exchanger 12 is extracted from the processing water in tank 17, in the above-described manner. The heat content of the second heat exchanger 18 is extracted from the moist exhaust air behind the fan 10 by a further heat exchanger 21, and is supplied by a pump 22 to the heat exchanger 18.

This allows on the one hand for the moisture contained in the exhaust air to condense on the surface of the heat exchanger 21, and is thus easily collected which substantially reduces the moisture content of the exhaust exiting the apparatus into the ambient air, while on the other hand the residual surface moisture adhering to the granulate can be further reduced in an advantageous manner.

A further advantage of the invention is the gentle form of drying as the granulate is subjected to substantially less mechanical stress in the vibrating chutes than in a centrifugal dryer. As concerns composite granulates, this provides considerably more degrees of freedom in selecting the types of compositions, and the mixture ratios of the individual components.

Additional advantages are that the drying can be accomplished practically without wear of the apparatus or its parts and that far less servicing is required which advantageously reduces the downtime of the device. Furthermore, a substantial reduction of dust content in the granulate product is achievable.

What is claimed is:

1. Process for the drying of plastic granulates composed of any base materials, especially of composite materials, said granulates being produced using the under-water or water-ring granulation principle or a similar technology where the granulate is fed from the granulating device to a gravity water separator (1) by means of a processing water stream and thereafter to a drying device (2), characterized in that inside the drying device (2), heated ambient air is aspirated through the granulate, the supplied heat content of the heated ambient air being extracted from the processing water by means of a heat exchanger (12).

2. Process according to claim 1, characterized in that the granulate is transported in a mechanically very gentle manner by means of the gravity water separator (1) and the drying device (2), especially by means of perforated vibration chutes (3, 6).

3. Process according to claim 1 or 2, characterized in that the supplied outside air is passed through at least one air-water heat exchanger (12) after passing through an air filter (11).

4. Process according to claim 1, 2 or 3, characterized in that the process water cooled in the heat exchanger 12 is returned to the water tank (17) and/or to the granulation unit.

5. Process according to claim 1, 2, 3 or 4, characterized in that the temperature of the granulating unit is regulated by the flow velocity of the water being pumped through the heat exchanger (12).

6. Process according to any of the claims 1 to 5, characterized in that the outside air aspirated for the drying of the granulate is divided into two streams and is heated by two spatially separated heat exchangers (12, 18) and that the granulate is impinged by these two heated air streams in succession, and that the heat content of the moist exhaust air enters a further heat exchanger (21) and is supplied to the second heat exchanger (18) which simultaneously condenses the moisture contained in the exhaust air, removing said moisture from the exhaust air stream.

7. Process according to any of the claims 1 to 6, characterized in that the drying takes place in two drying devices (2) disposed one after another, where in the first drying device (2) the heat content present in the exhaust stream is extracted by the heat exchanger (21) disposed in the exhaust hood (9) and is supplied to the heat exchanger (18) in the second drying device.

8. Device for drying plastic granulates composed of any base materials, especially of composite materials, manufactured according to the under-water granulation or the water-ring granulation principle or a comparable technology, comprising a gravity water separator (1) and at least one subsequent drying device (2) acting especially in accordance with a process according to any of the claims 1 to 7, characterized in that the drying device (2) comprises a housing (8) with a superimposed exhaust hood (9), a fan (10) disposed inside the exhaust hood (9) for aspiration of the moistened drying air, an air inlet embodied in form of an air filter, a conveyor device (6) serving to transport the granulate through the drying device (2) and designed to be air permeable,. and an air heating device (12) arranged between the air filter (1) and the conveyor device (6).

9. Device according to claim 8, characterized in that the air heating device (12) is an air-water heat exchanger.

10. Device according to claim 8 or 9, characterized in that underneath the gravity water separator (1), there is arranged a water tank (17) and the heat exchanger and that the heat exchanger (12) is supplied with the processing water from the water tank (17) by means of a pump (15).

11. Device according to claim 8, 9 or 10, characterized in that the processing water flowing back from the heat exchanger (12) is fed into the water tank (17).

12. Device according to any of the claims 8 to 11, characterized in that the processing water flowing back from the heat exchanger (12) is fed directly into the granulating unit.

13. Device according to any of the claims 8 to 12, characterized in that the processing water is pumped from the water tank (17) to the under-water granulator by a pump (13).

14. Device according to any of the claims 8 to 13, characterized in that the granulate is transported by means of two perforated vibrating chutes from the under-water granulator through the gravity water separator (1) and the subsequent drying device

15. Device according to any of the claims 8 to 14, characterized in that the space underneath the vibrating chute (6) is divided into two separate spaces (19, 23) by a dividing plate (20) and that in each space there is one heat exchanger (12, 18) and that behind the fan (10) there is arranged a further heat exchanger (21) which extracts the heat content of the exhaust air and supplies it by means of a pump (22) to the heat exchanger (18).

16. Device according to any of the claims 8 to 15, characterized in that behind the gravity water separator (1) there are provided two drying devices (2) disposed one behind the other, where in the first drying device (2) there is disposed the heat exchanger (12) and in the second drying device there is disposed the heat exchanger (18), as well as within the exhaust hood (9) of the first drying device (2) there is disposed the heat exchanger (21) and that the heat content of the exhaust air from the first drying device (2) is supplied to the heat exchanger (18) by means of a pump (22).

17. A process of drying plastic granulates of one or more base materials, said granulates being produced using an under-water or water-ring granulation method or another method wherein the granulates are formed in water, said process comprising: feeding the granulates from a granulating device to a gravity water separator by a processing water stream and thereafter to a drying device, wherein inside the drying device, heated ambient air is aspirated through the granulates, and wherein at least some of the heat content of the heated ambient air is extracted from the processing water by a heat exchanger and supplied to heat the ambient air aspirated through the granulates.

18. The process according to claim 17, wherein the granulates are transported in a mechanically gentle manner by the gravity water separator and the drying device.

19. The process according to claim 17, wherein the heat exchanger is an air-water heat exchanger, and the aspirated ambient air is passed through said air-water heat exchanger after passing through an air filter.

20. The process according to claim 17, wherein the processing water cooled in the heat exchanger is returned to the water tank and/or to the granulating device.

21. The process according to claim 20, wherein a temperature of the granulating device is regulated by a flow velocity of the water being pumped through the heat exchanger.

22. The process according to claim 17, wherein the ambient air aspirated through the granulates is divided into two air streams and is heated by said heat exchanger and a second spatially separated heat exchanger and wherein the granulates are impinged upon by the two heated air streams in succession, and wherein a heat content of a moist exhaust air enters a third heat exchanger and is supplied to the second heat exchanger, which simultaneously condenses moisture contained in the exhaust air, removing said moisture from the exhaust air.

23. The process according to claim 17, wherein the drying takes place in said drying device and a second drying device disposed one after another, wherein in the first drying device a heat content present in an exhaust stream is extracted by the heat exchanger disposed in an exhaust hood and is supplied to a second heat exchanger in the second drying device.

24. The process according to claim 17, wherein the granulates are composed of composite materials.

25. The process according to claim 17, wherein the granulates are transported using perforated vibration chutes.

26. A device for drying plastic granulates of one or more base materials manufactured according to an under-water granulation or water-ring granulation method or a method wherein the granulates are formed in water, said device comprising: a gravity water separator and at least one subsequent drying device receiving granulates therefrom, wherein the drying device comprises a housing with a superimposed exhaust hood, a fan disposed inside the exhaust hood and aspirating moistened drying air, an air inlet having an air filter, a conveyor device transporting the granulates through the drying device and being configured to be air permeable, and an air heating device arranged between the air filter and the conveyor device.

27. The device according to claim 26, wherein the air heating device is an air-water heat exchanger.

28. The device according to claim 26, wherein a water tank and a heat exchanger are arranged underneath the gravity water separator and wherein the heat exchanger is supplied with processing water from the water tank by a pump.

29. The device according to claim 28 wherein processing water flowing back from the heat exchanger is fed into the water tank.

30. A device according to claim 26, wherein processing water flowing back from a heat exchanger is fed directly into a granulating unit.

31. A device according to claim 26, wherein processing water is pumped from a water tank to an under-water granulator by a pump.

32. A device according to claim 26, wherein the granulate is transported by two perforated vibrating chutes from an under-water granulator through the gravity water separator and the subsequent drying device

33. A device according to claim 26, wherein a space underneath a vibrating chute is divided into two separate spaces by a dividing plate and wherein in each space is a heat exchanger and wherein behind the fan is arranged a third heat exchanger which extracts a heat content of an exhaust air and supplies said heat content using a pump to the heat exchanger.

34. A device according to claim 26, wherein behind the gravity water separator provided two drying devices are disposed one behind another, wherein a heat exchanger is disposed in a first drying device and a second heat exchanger is disposed in a second drying device, and within an exhaust hood of the first drying device is disposed a third heat exchanger and wherein a heat content of exhaust air from the first drying device is supplied to the second heat exchanger by a pump.

35. A device according to claim 26, wherein the plastic granulates are composed of a composite material.
